(19) United States
(12) Patent Application Publication
(10) Pub. No.: US 2013/0159302 A1
(43) Pub. Date: Jun. 20, 2013

(54) INSTANT DYNAMIC STRATEGY SYSTEM AND METHOD

(71) Applicants: Ching-Yao Huang, Hsinchu (TW); Shih-Heng Cheng, Hsinchu (TW); Wei Chou, Hsinchu (TW); Meng-Tieh Hsieh, Hsinchu (TW)

(72) Inventors: Ching-Yao Huang, Hsinchu (TW); Shih-Heng Cheng, Hsinchu (TW); Wei Chou, Hsinchu (TW); Meng-Tieh Hsieh, Hsinchu (TW)

(21) Appl. No.: 13/644,610

(22) Filed: Oct. 4, 2012

(30) Foreign Application Priority Data
Dec. 16, 2011 (TW) 100146745

(51) Int. Cl. G06F 17/30

(52) U.S. Cl. 707/736; 707/E17.005

(57) ABSTRACT

An instant dynamic strategy method is provided for dynamically providing a strategy according to external sensed information. The method includes receiving external sensed information; analyzing the sensed information so as to generate target data and conditional data according to user requirements; and transmitting the target data and the conditional data to an external dynamic strategy module such that the dynamic strategy module collects and analyzes strategic data according to the target data and the conditional data so as to generate a strategy. Compared with prior art that provides strategies based on fixed databases and fixed strategic rules, the present invention takes into account external information so as to achieve a desired strategic effect.

### BACKGROUND OF THE INVENTION

1. Field of the Invention

The present invention relates to instant dynamic strategy systems and methods, and, more particularly, to a system and method that dynamically provides strategies according to information from sensors and cloud networks.

2. Description of Related Art

Information processing technologies have greatly improved people's life quality and work performance. In the present era of information explosion, how to instantly obtain useful information is becoming more and more important.

Currently, information is obtained in a machine-to-machine manner, in which target data and conditional data are inputted and analyzed so as to obtain desired information. In other words, data is inputted through, for example, a computer, a mobile device or a personal digital assistant (PDA) to a processing machine for processing, which is just like a dialogue between machines without involvement of people. Generally, data resources can come from external sensors and can be analyzed according to certain predefined rules so as to generate corresponding answers. For example, when a driver inputs a destination into a navigation system for route planning, the navigation system acquires data from an internal database or from a server so as to display a route to the driver. In another example, a patient is equipped with a physiological sensing device such that when the patient has abnormal physical signs, the device can inform personnel of related information or change its settings.

Although such a machine-to-machine method facilitates information acquisition, it has some drawbacks. Since the machine-to-machine method acquires data from fixed databases and uses predefined processing rules, it leads to a limited strategic range or content. That is, if requirements do not fall within the predefined processing rules or ranges, the method cannot provide a desired strategy. Even if some systems have self-learning capabilities so as to provide strategies by reasoning when requirements fall beyond the processing rules, the reasoning results are quite limited due to various data types.

Therefore, there is a need to provide a dynamic strategy mechanism through which user end devices obtain dynamic strategy capabilities with strategic contents not only coming from pre-stored data in databases, thereby providing desired strategies and overcoming the conventional drawbacks of limited contents of databases, limited processing rules and simple self-learning capabilities.

### SUMMARY OF THE INVENTION

Accordingly, the present invention provides an instant dynamic strategy system for dynamically providing a strategy according to external sensed information, wherein the external sensed information can comprise cloud information. The instant dynamic strategy system comprises: a processing unit for analyzing the external sensed information so as to generate target data and conditional data according to user requirements; and a strategic unit for providing a strategy according to the target data and the conditional data, wherein the strategic unit transmits the target data and the conditional data to an external dynamic strategy module, and the dynamic strategy module collects and analyzes strategic data according to the target data and the conditional data to thereby generate the strategy, and further transmits the strategy back to the strategic unit.

In an embodiment, the dynamic strategy module is a semantic web or a cloud server.

In an embodiment, the strategic unit further modifies the target data and the conditional data according to the strategy generated by the dynamic strategy module and transmits the modified target and conditional data to the dynamic strategy module for generating another strategy.

The present invention further provides an instant dynamic strategy method, which comprises the steps of: (1) receiving external sensed information; (2) analyzing the external sensed information so as to generate target data and conditional data according to user requirements; and (3) transmitting the target data and the conditional data to an external dynamic strategy module such that the dynamic strategy module collects and analyzes strategic data according to the target data and the conditional data to thereby generate a strategy.

In an embodiment, the method further comprises modifying the target data and the conditional data according to the strategy generated at step (3) so as to perform step (3) again, thereby generating another strategy.

Compared with the prior art that provides strategies only based on fixed databases or fixed strategic rules so as to result in a limited strategic reference range and undesired strategies, the instant dynamic strategy system and method of the present invention integrates internal data and external sensed information so as to provide a wide range of strategic references, thereby achieving a desired strategic effect.

### BRIEF DESCRIPTION OF DRAWINGS

FIG. 1 is a block diagram showing an instant dynamic strategy system according to the present invention;

FIG. 2 is a flow diagram showing an instant dynamic strategy method according to the present invention;

FIG. 3 is a schematic view showing an example of application of the instant dynamic strategy system according to the present invention;

FIG. 4 is a schematic view showing another example of application of the instant dynamic strategy system according to the present invention; and

FIG. 5 is a schematic view showing a further example of application of the instant dynamic strategy system according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

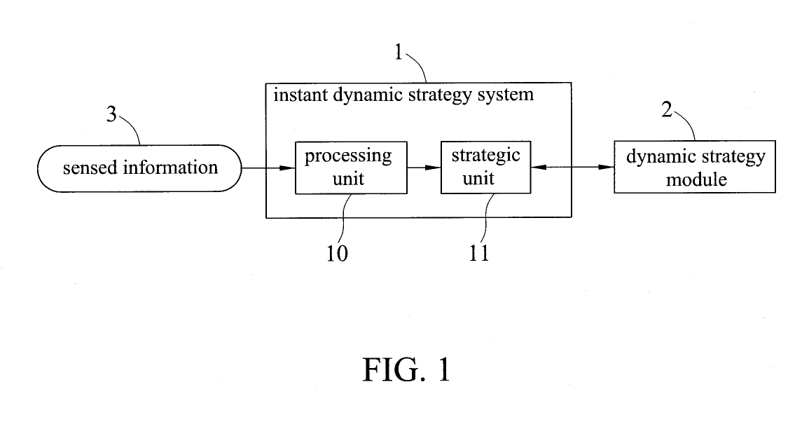

FIG. 1 is a block diagram showing an instant dynamic strategy system according to the present invention. The instant dynamic strategy system 1 is implemented through software or hardware and used for integrating internal data and external sensed information so as to dynamically provide a strategy. The instant dynamic strategy system 1 has a processing unit 10 and a strategic unit 11.

The processing unit 10 is used for analyzing sensed information 3 so as to generate target data and conditional data according to user requirements. For example, a user requirement is to find nearby discount stores, and the sensed information 3 provides positioning data of the user. By analyzing the sensed information 3, the processing unit 10 generates target data of stores near the user's position and the conditional data of stores having discount activities.

The strategic unit 11 is used for providing a strategy according to the target data and the conditional data. In particular, the strategic unit 11 transmits the target data and the conditional data to an external dynamic strategy module 2, and the dynamic strategy module 2 generates a strategy according to the target data and the conditional data and further transmits the strategy back to the strategic unit 11 so as for the user to refer to.

In another embodiment, before transmitting the target data and the conditional data to the dynamic strategy module 2, the strategic unit 11 can provide a strategy based on the target data and the conditional data if the target data and the conditional data fall within a predefined strategic range. The predefined strategic range refers to predefined processing rules and pre-stored data in databases of the instant dynamic strategy system 1. As described previously, the internal databases have a limited quantity of data, which results in a limited strategic range. Therefore, such a strategy method is only an embodiment and does not intend to limit the present invention. Otherwise, if the target data and the conditional data fall beyond the predefined strategic range, the strategic unit 11 transmits the target data and the conditional data to the dynamic strategy module 2.

The dynamic strategy module 2 can be a semantic web, a cloud server, or any other strategy module capable of generating a strategy according to the target data and the conditional data in combination with the newest information. In particular, the dynamic strategy module 2 can be a network, a server capable of actively searching for answer information or a cloud server having a huge data support. Different from internal databases, the semantic web provides instant dynamic strategies. Since information on the network increases or updates at times, different strategies may be provided at different time for the same target data and the same conditional data. Therefore, strategies are not limited to the pre-stored data as in the prior art.

The external sensed information 3 received by the instant dynamic strategy system 1 can be information inputted by a user, pre-stored reference information, information sensed by a sensing device connected to the system 1 or in a network that is the same as or different from that of the system 1, or interactive information of one or more other instant dynamic strategy systems. The instant dynamic strategy system 1 takes into account the sensed information 3 so as to provide more accurate target data and conditional data, thereby providing more effective strategies.

For example, a conventional intelligent wash machine can automatically identify the materials of clothes and choose corresponding washing programs from its built-in database. However, for a new material of clothes, since the intelligent wash machine cannot identify the new material and cannot find a corresponding washing program in its database, the intelligent wash machine cannot operate. The problem can be overcome by the instant dynamic strategy system 1. If the intelligent wash machine cannot identify the new material, related external sensed information 3 is transmitted to the dynamic strategy module 2 such as a semantic web through the instant dynamic strategy system 1. Further, the semantic web searches for information about washing suggestions on, for example, the manufacturer's website, webpages including washing suggestions about the new material, or clothes washing forums and transmits the searched washing suggestions back to the system 1. As such, the intelligent wash machine can wash the clothes according to the searched washing suggestions.

In an embodiment, besides the target data and the conditional data, the pre-stored data of the instant dynamic strategy system 1 is also transmitted by the strategic unit 10 to the dynamic strategy module 2 to serve as a reference for the dynamic strategy module 2.

In another embodiment, the strategic unit 11 further modifies the target data and the conditional data according to the strategy and transmits the modified target and conditional data to the dynamic strategy module for generating another strategy. In particular, if the strategy generated by the dynamic strategy module 2 does not meet the user's requirements, the strategic unit 11 allows the user to adjust the target data and the conditional data according to the strategy and further transmits the adjusted target data and conditional data to the dynamic strategy module 2 for generating another desired strategy.

For example, the instant dynamic strategy system 1 can be implemented through software, circuits or firmware, and be disposed in portable devices for capturing sensed information 3 from peripheral sensors, thereby assisting the user to obtain desired information. The instant dynamic strategy system 1 further has a communication unit (not shown) for data transmission or a memory unit (not shown) for storing data. Since the communication unit or the memory unit is not the main characteristics of the instant dynamic strategy system 1, detailed description thereof is omitted herein.

Compared with the prior art that has a limited strategic range due to fixed databases and fixed processing rules, the instant dynamic strategy system 1 of the present invention can obtain desired information from external sources, such as a large number of webpages, websites and servers, through the dynamic strategy module 2, thereby achieving a desired strategic effect.

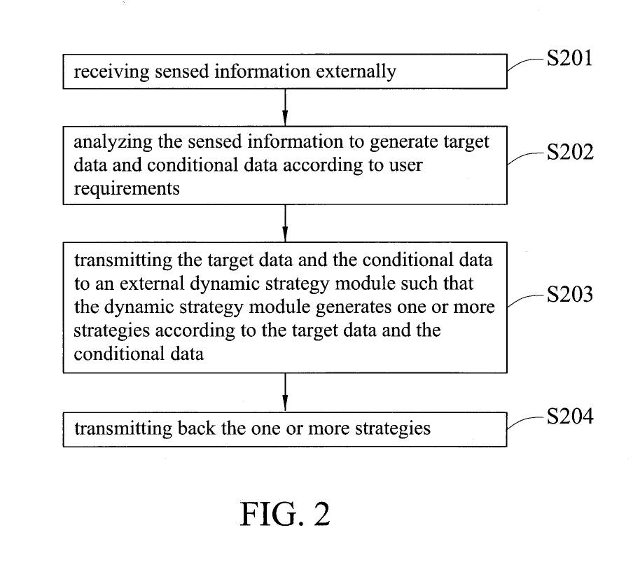

FIG. 2 shows a flow diagram of an instant dynamic strategy method according to the present invention. At step S201, external sensed information is received. The sensed information can be inputted by a user, stored in an external database, sensed by a sensing device connected to the system or in a network that is the same as or different from that of the system, or comes from one or more other instant dynamic strategy systems. The sensed information can come from one single source or multiple sources. The sensed information can be user environment information or other effective information. Then, the method goes to step S202.

At step S202, the sensed information is analyzed so as to generate target data and conditional data according to user requirements. In the above-described intelligent wash machine, the target data is suitable washing programs for the clothes or washing precautions, and the conditional data is the fiber materials of the clothes. Then, the method goes to step S203.

At step S203, the target data and the conditional data are transmitted to an external dynamic strategy module such that the dynamic strategy module generates one or more strategies according to the target data and the conditional data. In particular, the target data and the conditional data are transmitted to, for example, a semantic web which searches for one or more strategies according to the target data and the conditional data.

The dynamic strategy module can be a semantic web, a cloud server, or any other strategy module capable of generating a strategy according to the target data and the conditional data in combination with the newest information. For example, the dynamic strategy module can be a network, a server capable of actively searching for answer information or a cloud server having a huge data support.

Before transmitting the target data and the conditional data to the dynamic strategy module, step S203 can further include providing a strategy based on the target data and the conditional data according to predefined strategic data. Further, in addition to the target data and the conditional data, pre-stored data of the system can also be transmitted to the dynamic strategy module so as to serve as a reference for the dynamic strategy module. Then, the method goes to step S204.

At step S204, one or more strategies are transmitted back to the user end so as for the user to refer to or choose, thereby overcoming the conventional drawback of the strategic limitation due to fixed database or fixed processing rules.

In an embodiment, the instant dynamic strategy method further includes modifying the target data and the conditional data according to the strategy generated at step S204 so as to perform step S203 again, thereby generating another strategy. In particular, if the strategy transmitted to the user end does not meet the user's requirements, the target data and the conditional data can be modified according to the strategy and further transmitted to the dynamic strategy module for generating another desired strategy.

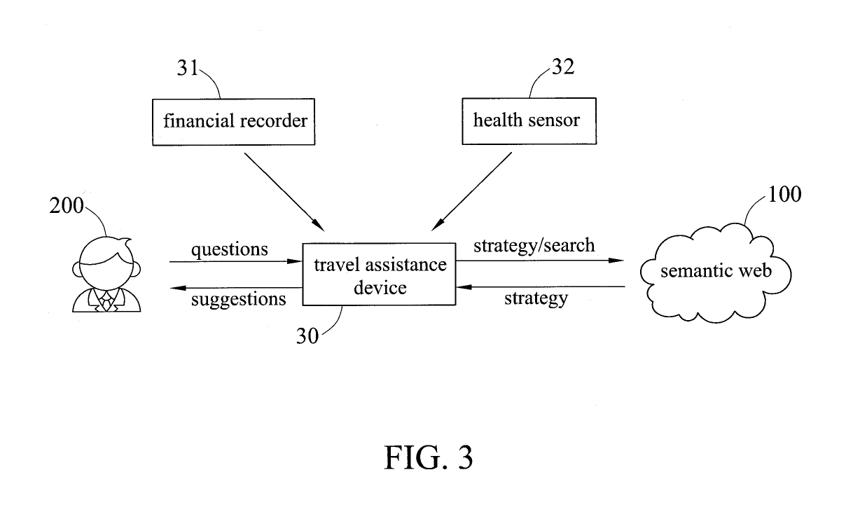

FIGS. 3 to 5 show examples of application of the instant dynamic strategy system according to the present invention.

FIG. 3 shows an application of the instant dynamic strategy system according to a first embodiment of the present invention. Referring to FIG. 3, the instant dynamic strategy system is performed on a travel assistance device 30. The travel assistance device 30 analyzes questions inputted by a user 200 or information stored in a financial recorder 31 or health data sensed by a health sensor 32 so as to generate target data and conditional data and further transmits the target data and the conditional data to a semantic web 100. Then, the semantic web 100 generates strategies, such as route suggestions or luggage suggestions, according to the target data such as a travel route and the conditional data such as weather condition of the destination and health condition of the user in combination with information such as weather information obtained by the semantic web 100, thereby providing a desired strategy that takes into account the weather, the health condition of the user and so on.

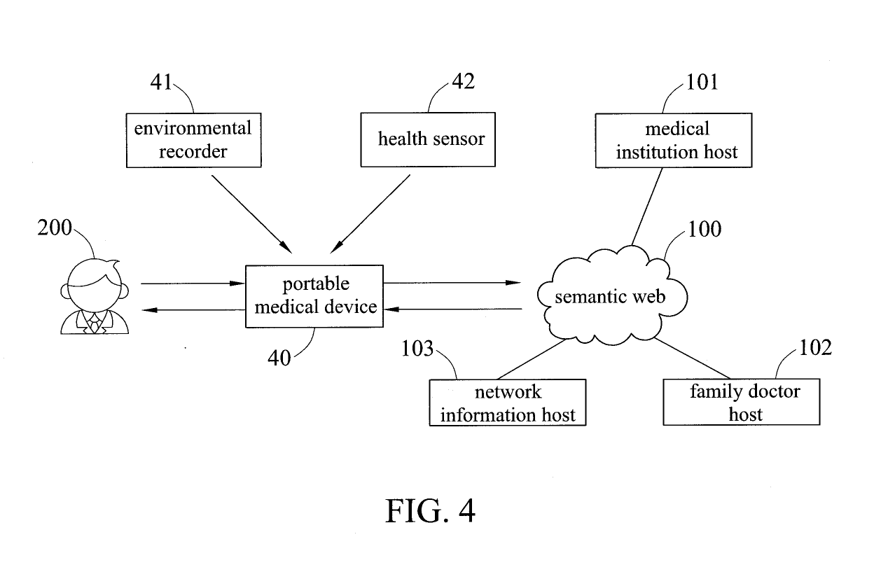

FIG. 4 shows an application of the instant dynamic strategy system according to a second embodiment of the present invention. Referring to FIG. 4, the instant dynamic strategy system is performed on a portable medical device 40. The portable medical device 40 analyzes data, such as requirements of a user 200, environmental data sensed by an environmental recorder 41, and health data sensed by a health sensor 42, so as to generate target data and conditional data, and further transmits the target data and the conditional data to a semantic web 100. The target data can be diagnosis of the user 200, and the conditional data can be health data from the health sensor 42 and the user's contact environment from the environmental recorder 41. According to the target data and the conditional data in combination with information obtained by the semantic web 100, the semantic web 100 provides strategies such as immediate care suggestions, medical suggestions and dietary suggestions to the user.

Referring to FIG. 4, the semantic web 100 can obtain information from other devices in the same network as the semantic web 100, for example, a medical institution host 101, a family doctor host 102 or a network information host 103.

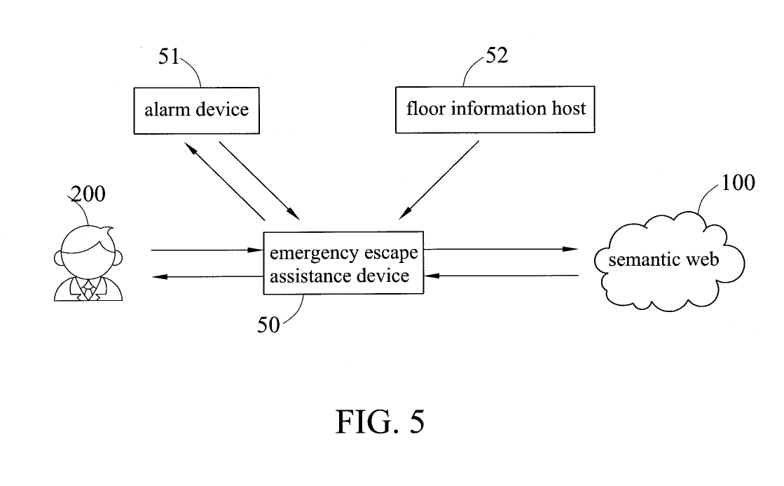

FIG. 5 shows an application of the instant dynamic strategy system according to a third embodiment of the present invention. The instant dynamic strategy system is performed on an emergency escape assistance device 50. The emergency escape assistance device 50 can obtain information from an alarm device 51 or other devices such as a floor information host 52 in the same network as the emergency escape assistance device 50 by using a wireless transmission technique, such as WiFi or Bluetooth. The emergency escape assistance device 50 analyzes the obtained information to generate target data and conditional data, and further transmits the target data and the conditional data to the dynamic strategy module such as a semantic web 100. The target data can be an optimal escape route, and the conditional data can be floor damage condition or structure information from the floor information host 52, an emergency category and fire status from the alarm device 51, or user location and health condition captured from or inputted by the user 200. According to the target data and the conditional data in combination with instantly obtained rescue information, the semantic web 100 generates an optimal strategy such as an optimal escape route for the user 200.

Compared with the prior art that provides strategies only based on fixed databases or fixed strategic rules so as to result in a limited strategic reference range and undesired strategies, the instant dynamic strategy system and method of the present invention integrates internal data and external sensed information to generate target data and conditional data. Further, based on the target data and the conditional data in combination with more information obtained by the dynamic strategy module, the dynamic strategy module generates optimal strategies to thereby overcome the conventional drawback of the strategic limitation. In addition, the present invention can be widely applied in such as data search, emergency information integration, medical care and intelligent appliances without any special limitation.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An instant dynamic strategy system for dynamically providing a strategy according to external sensed information, comprising:
a processing unit for analyzing the external sensed information received by the processing unit so as to generate target data and conditional data according to user requirements; and
a strategic unit for providing a strategy according to the target data and the conditional data, wherein the strategic unit transmits the target data and the conditional data to an external dynamic strategy module, and the dynamic strategy module collects and analyzes strategic data according to the target data and the conditional data to thereby generate the strategy, and further transmits the strategy back to the strategic unit.

2. The system of claim 1, wherein the dynamic strategy module is a semantic web or a cloud server.

3. The system of claim 1, wherein the external sensed information is information inputted by a user, information stored in an external database, information sensed by a sensing device connected to the system or in a network that is the same as or different from that of the system, or interactive information of one or more other instant dynamic strategy systems.

4. The system of claim 1, wherein the strategic unit further modifies the target data and the conditional data according to the strategy generated by the dynamic strategy module and transmits the modified target and conditional data to the dynamic strategy module for generating another strategy.

5. The system of claim 1, wherein the strategic unit provides the strategy according to predefined strategic data, wherein the predefined strategic data refers to pre-processed rules and pre-stored data in a database of the instant dynamic strategy system.

6. An instant dynamic strategy method, comprising the steps of:
(1) receiving external sensed information;
(2) analyzing the sensed information so as to generate target data and conditional data according to user requirements; and
(3) transmitting the target data and the conditional data to an external dynamic strategy module such that the dynamic strategy module collects and analyzes strategic data according to the target data and the conditional data to thereby generate a strategy.

7. The method of claim 6, wherein the sensed information is inputted by a user, stored in an external database, sensed by a sensing device connected to the system or in a network that is the same as or different from that of the system, or from one or more other instant dynamic strategy systems.

8. The method of claim 6, wherein the dynamic strategy module is a semantic web or a cloud server.

9. The method of claim 6, further comprising, prior to transmitting the target data and the conditional data to the external dynamic strategy module at step (3), providing a strategy based on the target data and the conditional data according to predefined strategic data.

10. The method of claim 6, further comprising modifying the target data and the conditional data according to the strategy generated at step (3) so as to perform step (3) again, thereby generating another strategy.
